(19) United States
(12) Patent Application Publication
(10) Pub. No.: US 2019/0113932 A1
(43) Pub. Date: Apr. 18, 2019

(54) APPARATUS FOR POSITIONING A TRAILER

(71) Applicant: TRW Automotive U.S. LLC, Livonia, MI (US)

(72) Inventor: Daniel E. Williams, Carmel, IN (US)

(21) Appl. No.: 16/163,850

(22) Filed: Oct. 18, 2018

Related U.S. Application Data
(60) Provisional application No. 62/573,709, filed on Oct. 18, 2017.

(51) Int. Cl. G05D 1/02; B60P 1/02; B60D 1/62

(52) U.S. Cl. CPC G05D 1/0231; B60P 1/02; G05B 2219/40003; G05D 2201/0207; G05B 2219/40298; B60D 1/62

(57) ABSTRACT

An apparatus for use in positioning a trailer includes an autonomous unit connectable with the trailer and having at least one wheel. A sensor unit connected to the autonomous unit determines the position and/or speed of the autonomous unit. A controller receives the at least one signal from the sensor unit and controls the direction and/or speed of movement of the autonomous unit.

### TECHNICAL FIELD

The present invention relates to an apparatus for use in positioning a trailer.

### BACKGROUND OF THE INVENTION

Loading docks are provided in buildings for the loading and unloading of products and items into and out of a vehicle, such as a truck trailer. A typical loading dock may have painted lines on the ground to assist an operator of the vehicle when backing the vehicle into proper position. The lines may fade over time and may be difficult for the operator to see which may cause difficulty in backing the vehicle into proper position.

### SUMMARY OF THE INVENTION

The present invention is directed to an apparatus for use in positioning a trailer. The apparatus includes an autonomous unit connectable with the trailer and having at least one wheel. A sensor unit connected to the autonomous unit determines the position and/or speed of the autonomous unit. A controller receives the at least one signal from the sensor unit and controls the direction and/or speed of movement of the autonomous unit.

### BRIEF DESCRIPTION OF THE DRAWINGS

Embodiments of the invention will now be described by way of example only, with reference to the accompanying drawings, in which:

FIG. 1 is a schematic side view of a first embodiment of an apparatus for positioning a trailer connected to a trailer;

FIG. 2 is a bottom view of the apparatus for positioning a trailer and trailer of FIG. 1; and

FIG. 3 is a schematic side view of a second embodiment of an apparatus for positioning a trailer.

### DESCRIPTION

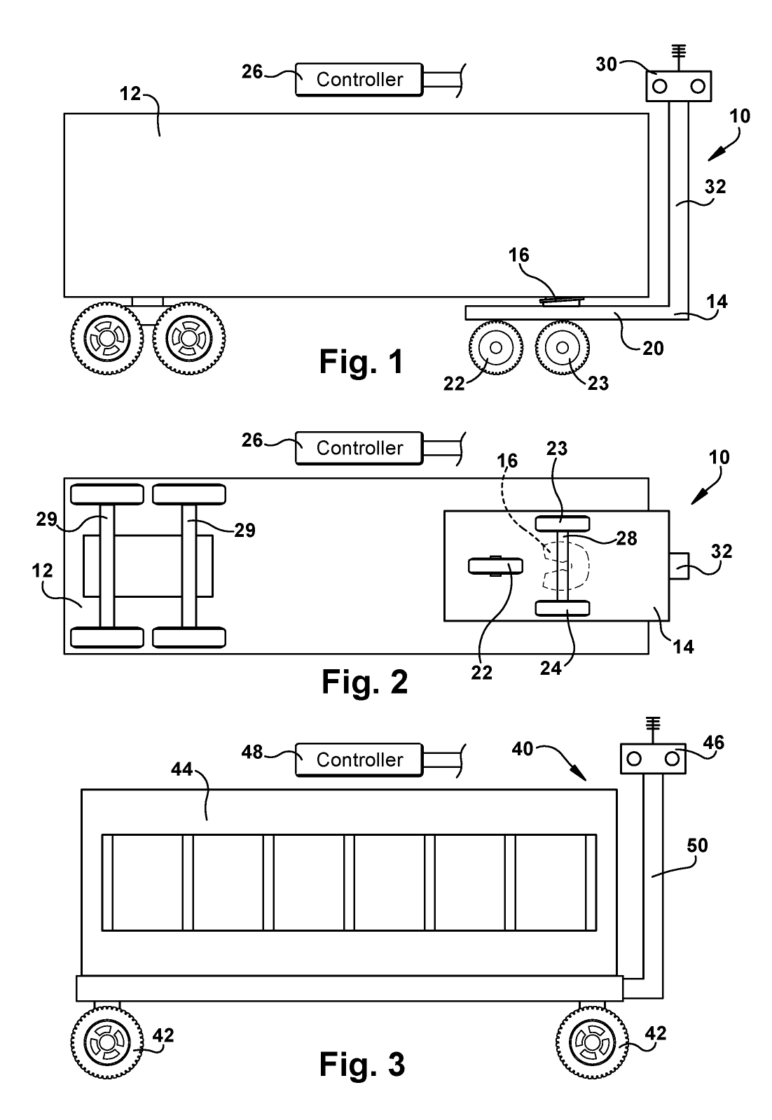

The present invention relates to an apparatus 10 (FIGS. 1 and 2) for use in positioning or docking a trailer 12. The apparatus 10 includes an autonomous unit 14 that connects to the fifth wheel of the trailer 12 to be positioned or docked. The autonomous unit 14 has a base 20 that connects to the fifth wheel 16 of the trailer 12. An electric drive may cause rotation of steerable wheels 22, 23 and 24 to move the autonomous unit 14. The autonomous unit 14 may communicate with a controller 26 that controls movement of the autonomous unit. The autonomous unit 14 may communicate with the controller 26 in any desired manner, such as wirelessly.

The first steerable wheel 22 may be located along a center line of the autonomous unit 14 and moved to help control the direction of travel of the autonomous unit 14. The second and third steerable wheels 23 and 24 may be mounted on a steerable drive axle 28. The steerable drive axle 28 may be moved to help control the direction of travel of the autonomous unit 14.

The connection for the fifth wheel 16 may be located directly above a centerline of the steerable drive axle 28 and between the second and third steerable wheels 23, 24, see FIG. 2. The first steerable wheel 22 may be located between the steerable drive axle 28 and the axles 29 of the trailer 12 when the autonomous unit 14 is connected to the trailer. It is also contemplated that the drive mechanism and any batteries for the drive mechanism may load the first steerable wheel 22 to help prevent the autonomous unit 14 from tipping over due to the weight of the trailer 12.

The autonomous unit 14 may include a sensor unit 30 that communicates with the controller 26 for controlling movement of the autonomous unit. The controller 26 may be spaced from the autonomous unit 14 and communicate with the sensor unit 30 wirelessly. It is also contemplated that the controller 26 may be connected to the autonomous unit 14.

The sensor unit 30 may be mounted on a vertically extending member 32. The vertically extending member 32 may extend from the base 20 to a height above the trailer 12. The sensor unit 30 may include radar, lidar, cameras and/or V2X communication. The sensor unit 30 may send at least one signal to the controller 26 indicating the position and/or speed of the autonomous unit 14. The controller 26 may control steering of the steerable wheels 22, 23 and 24 and/or the rotational speed of the steerable wheels in response to signals received from the sensor unit 30 to control the direction and/or speed of movement of the autonomous unit 14. The controller 26 may have a desired position for the trailer 12 stored in its memory and control movement of the autonomous unit 14 to the desired position.

It is contemplated that each wheel 22, 23 and 24 may have an independent electric drive so that steering of the wheels is not required. The autonomous unit 14 may be positioned by torque vectoring. It is also possible that the wheels 23 and 24 on the axle may be torque vectored and the wheel 22 caster steered.

An autonomous unit 40 (FIG. 3) having four wheels 42 may be used to position a shipping container 44 at a port. The wheels 42 of the autonomous unit 40 may be independently torque vectored or steered to position the shipping container 44.

The autonomous unit 40 may include a sensor unit 46 that communicates with a controller 48 for controlling movement of the autonomous unit. The controller 48 may be spaced from the autonomous unit 40 and communicate with the sensor unit 46 wirelessly. It is also contemplated that the controller 48 may be connected to the autonomous unit 40. The sensor unit 46 may be mounted on a vertically extending member 50. The sensor unit 46 may send at least one signal to the controller 48 indicating the position and/or speed of the autonomous unit 40. The controller 48 may control steering of the wheels 42 and/or the rotational speed of the wheels in response to signals received from the sensor unit 46 to control the direction and/or speed of movement of the autonomous unit 40.

From the above description of the invention, those skilled in the art will perceive improvements, changes and modifications. Such improvements, changes and modifications within the skill of the art are intended to be covered by the appended claims.

Having described the invention, the following is claimed:

1. An apparatus for use in positioning a trailer, the apparatus comprising:
an autonomous unit connectable with the trailer and having at least one wheel, a sensor unit connected to the autonomous unit that determines the position and/or speed of the autonomous unit; and
a controller that receives the at least one signal from the sensor unit and controls the direction and/or speed of movement of the autonomous unit.

2. An apparatus as set forth in claim 1 wherein the at least one wheel includes a first wheel located along a center line of the autonomous unit.

3. An apparatus as set forth in claim 2 further including second and third wheels mounted on a steerable drive axle.

4. An apparatus as set forth in claim 3 wherein a connection for a fifth wheel of the trailer is located directly above a centerline of the steerable drive axle.

5. An apparatus as set forth in claim 3 wherein the first wheel 22 is located between the steerable drive axle and axles the trailer when the autonomous unit is connected to the trailer.

6. An apparatus as set forth in claim 1 wherein the sensor unit is mounted on a vertically extending member.

7. An apparatus as set forth in claim 6 wherein the vertically extending member extend from a base to a height above the trailer when the autonomous unit is connected to the trailer.

8. An apparatus as set forth in claim 1 wherein the sensor unit includes at least one of radar, lidar, cameras and/or V2X communication.

9. An apparatus as set forth in claim 1 wherein the sensor unit sends at least one signal to the controller indicating the position and/or speed of the autonomous unit.

10. An apparatus as set forth in claim 1 wherein the controller controls steering of the at least one wheel and/or the rotational speed of the at least one wheel in response to a signal received from the sensor unit to control the direction and/or speed of movement of the autonomous unit.
